(19) United States
(12) Patent Application Publication
(10) Pub. No.: US 2022/0089022 A1
(43) Pub. Date: Mar. 24, 2022

(54) UTILIZATION OF THE VF SERIES GEAR SET IN AN AUXILIARY GEARBOX UNIT TO PROVIDE REDUCED DRIVELINE OUTPUT SPEED

(71) Applicant: NORTHWEST FABWORKS INC., Parksville (CA)

(72) Inventor: Kyle KUSZNIERYK, Qualicum Beach (CA)

(21) Appl. No.: 17/483,493

(22) Filed: Sep. 23, 2021

Related U.S. Application Data
(60) Provisional application No. 63/083,011, filed on Sep. 24, 2020.

(51) Int. Cl. B60K 17/346; F16H 3/54; F16H 37/06

(52) U.S. Cl. CPC B60K 17/3467; F16H 3/54; F16H 2200/2005; F16H 2200/0034; F16H 37/065

(57) ABSTRACT

An auxiliary gearbox comprising a VF series transfer case input shaft, a VF series transfer case epicyclic gear set and a range collar. The epicyclic gear set comprises a sun gear connected to the input shaft, a plurality of planetary gears engaged with the sun gear, a planetary gear carrier connected to each of the planetary gears and a ring gear engaged with each of the planetary gears. An output shaft is selectively engageable to the input shaft via the range collar when the range collar is in a first position and the planetary gear carrier via the range collar when the range collar is in a second position. A first housing portion is attachable to a transmission. A second housing portion is attachable to a transfer case. The first housing portion and the second housing portion together house the epicyclic gear set.

### CROSS-REFERENCE TO RELATED APPLICATIONS

This application claims the benefit under 35 U.S.C. § 119 of US application No. 63/083011 filed 24 Sep. 2020 and entitled UTILIZATION OF THE VF SERIES GEAR SET IN AN AUXILIARY GEARBOX UNIT TO PROVIDE REDUCED DRIVELINE OUTPUT SPEED which is hereby incorporated herein by reference for all purposes.

### TECHNICAL FIELD

This invention relates generally to methods and apparatus for reducing driveline speed in a 4-wheel drive vehicle and, in particular, methods and apparatus for utilization of a VF series gear set in an auxiliary gearbox unit to provide reduced driveline output speed in a 4-wheel drive vehicle.

### BACKGROUND

Off-road driving is an extremely popular recreational activity. It is desirable for 4-wheel drive vehicles to traverse difficult terrain (e.g. large rocks, boulders, hills, sand, mud and other obstacles) without becoming stuck or damaged. Various parts on 4-wheel drive vehicles may assist in this task, such as, for example large knobby tires, locking differentials, and sufficient gear reduction to allow the driver to control the vehicle at low speeds. In some cases, the transfer case of a 4-wheel drive vehicle is equipped with an auxiliary gearbox unit to provide sufficient gear reduction to allow the driver to enjoy better control of the vehicle at lower speeds.

However, many 4-wheel drive vehicles are designed and built from the factory with an emphasis on highway driving, and therefore lack features (e.g. sufficient gear reduction) desired for navigating difficult terrain. If a vehicle is not properly equipped for this type of terrain from the factory, aftermarket modifications may be desirable.

Toyota is a popular brand that manufactures vehicles that are commonly modified for off-road use. Originally released in the late 1970s, Toyota pickup trucks (known outside North America as the ‘Hilux’) were released with a transfer case that is commonly referred to as the “RF1A transfer case”. The RF1A transfer case features an all gear design, with a top or forward shifter configuration. The RF1A comprises a gear reduction front section, with the middle and rear section providing selectable drive to the driveshaft(s). The RF1A transfer provides a relatively shallow gear reduction ratio of up to 2.28:1.

As off-roading became increasingly popular, enthusiasts desired gear reduction beyond the 2.28:1 gear reduction ratio provide by the RF1A transfer case. Those skilled in the art such as Marlin Czajkowski of Marlin Crawler developed an RF1A auxiliary gearbox made from parts of an RF1A transfer case to provide further gear reduction. Such an RF1A auxiliary gearbox can be mounted between an existing transmission and an RF1A transfer case. These RF1A auxiliary gearboxes required development of a mounting plate and shaft to connect to additional gear reduction section(s) removed from an RF1A gearbox.

The RF1A auxiliary gearbox was effective until Toyota released new types of transfer cases, commonly referred to as the “VF series transfer cases” in the 1980s. VF series transfer cases use an epicyclic gearset (also commonly referred to as a planetary gearset) to provide gear reduction in contrast to the countershaft design of the RF1A transfer case. Engine power is transmitted from a transmission by splined connection to a sun gear. When in high range (e.g. 1:1), a sliding range collar is directly engaged to the sun gear and an output shaft, bypassing the epicyclic gear reduction. In low range the sliding range collar is connected to a planetary gear carrier and the output shaft, allowing power to pass through the epicyclic gearset to provide a gear reduction of approximately 2.57:1.

Unlike the RF1A transfer case, in which the gear reduction section is easily isolated from the remainder of the transfer case, the gear reduction components of VF series transfer cases are housed deep inside a larger housing which does not permit easy isolation of the gear reduction components. Furthermore, unlike the RF1A transfer case which includes separate housing for the gear reduction components which can be re-purposed for the RF1A auxiliary gearbox, the gear reduction components of VF series transfer cases are located in a larger housing that is unsuitable to for use in an auxiliary gearbox.

Due at least in part to these difficulties, those skilled in the art such as Marlin Czajkowski of Marlin Crawler opted to develop adaptors and mounting provisions to mount an RF1A auxiliary gearbox to a transmission that was originally fitted with a VF series transfer case. Although effective in function, the additional adapters and mounting provisions increase weight and produce a drivetrain that is longer than desireable. Moreover, this solution potentially requires sourcing old components that may no longer be readily available.

There is a general desire to provide gear reduction solutions that are compatible with a transmission that was originally fitted with a VF series transfer case while being lighter, shorter in length and reliant on fewer mounting adaptors (as compared to solutions which employ components from an RF1A transfer case).

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides an auxiliary gearbox. The auxiliary gearbox comprises a VF series transfer case input shaft and a VF series transfer case epicyclic gear set. The epicyclic gear set comprises a sun gear connected to the input shaft, a plurality of planetary gears engaged with the sun gear, a planetary gear carrier connected to each of the plurality of planetary gears and a ring gear engaged with each of the planetary gears. An output shaft is selectively engageable to the input shaft via a range collar when the range collar is in a first position and selectively engageable to the planetary gear carrier via the range collar when the range collar is in a second position. A first housing portion is directly attachable to a transmission and a second housing portion, attached to the first housing portion and directly attachable to a transfer case. The first housing portion and the second housing portion together house the epicyclic gear set and the range collar.

In some embodiments, the auxiliary gearbox comprises a shift fork connected to the range collar to selectively move the range collar between the first position and the second position. In some embodiments, the shift fork is a VF series transfer case shift fork. In some embodiments, the shift fork is a modified VF series transfer case shift fork. In some embodiments, one of the first housing portion and the second housing portion defines an aperture to provide access to the shift fork.

In some embodiments, the VF series transfer case epicyclic gear set provides a gear reduction of between approximately 2:1 and 4:1. In some embodiments, the VF series transfer case epicyclic gear set provides a gear reduction of between approximately 2:1 and 3:1. In some embodiments, the VF series transfer case epicyclic gear set provides a gear reduction of approximately 2.57:1. In some embodiments, the sun gear comprises 53 teeth, each of the plurality of planetary gears comprise 15 teeth and the ring gear comprises 83 teeth.

In some embodiments, the VF series transfer case input shaft, the VF series transfer case epicyclic gear set and/or the range collar are re-purposed from one or more VF series transfer cases. In some embodiments, the VF series transfer case input shaft, the VF series transfer case epicyclic gear set and/or the range collar are re-purposed from parts manufactured for a VF series transfer case.

Another aspect of the invention provides a drivetrain comprising an auxiliary gearbox, a transmission attached to a first housing portion of the auxiliary gearbox and a transfer case attached to a second housing portion of the auxiliary gearbox, wherein the output shaft of the auxiliary gearbox is integrally formed with an input shaft of the transfer case.

Another aspect of the invention provides a method of installing an auxiliary gearbox. The method comprising attaching a transmission to a first housing portion of the auxiliary gearbox, attaching a transfer case to a second housing portion of the auxiliary gearbox and replacing an input shaft of the transfer case with at least a portion of the output shaft of the auxiliary gearbox.

Another aspect of the invention provides a method of fabricating an auxiliary gearbox. The method comprises re-purposing VF series transfer case input shaft and re-purposing a VF series transfer case epicyclic gear set. The epicyclic gear set comprises a sun gear connected to the input shaft, a plurality of planetary gears engaged with the sun gear, a planetary gear carrier connected to each of the plurality of planetary gears and a ring gear engaged with each of the planetary gears. The method also comprises providing a range collar, providing an output shaft selectively engageable to the input shaft via the range collar when the range collar is in a first position and selectively engageable to the planetary gear carrier via the range collar when the range collar is in a second position, providing a first housing portion, directly attachable to a transmission, providing a second housing portion, attached to the first housing portion and directly attachable to a transfer case and attaching the first housing portion to the second housing portion to house the epicyclic gear set.

In some embodiments, the method comprises connecting a shift fork to the range collar to selectively move the range collar between the first position and the second position. In some embodiments, connecting a shift fork to the range collar comprises re-purposing a VF series transfer case shift fork and connecting the re-purposed VF series transfer case shift fork to the range collar. In some embodiments, connecting a shift fork to the range collar comprises modifying a VF series transfer case shift fork and connecting the modified VF series transfer case shift fork to the range collar. In some embodiments, one of the first housing portion and the second defines an aperture to provide access to the shift fork.

In some embodiments, the VF series transfer case epicyclic gear set provides a gear reduction of between approximately 2:1 and 4:1. In some embodiments, the VF series transfer case epicyclic gear set provides a gear reduction of between approximately 2:1 and 3:1. In some embodiments, the VF series transfer case epicyclic gear set provides a gear reduction of approximately 2.57:1. In some embodiments, the sun gear comprises 53 teeth, each of the plurality of planetary gears comprise 15 teeth and the ring gear comprises 83 teeth.

In some embodiments, the method comprises re-purposing the VF series transfer case input shaft, the VF series transfer case epicyclic gear set and/or the range collar from one or more VF series transfer cases. In some embodiments, the method comprises re-purposing the VF series transfer case input shaft, the VF series transfer case epicyclic gear set and/or the range collar from parts manufactured for a VF series transfer case.

Another aspect of the invention provides a kit comprising a housing configured to receive gear components of a VF series transfer case and an output shaft for coupling said kit to a mating transfer case. In some embodiments, the housing comprises a first housing portion, directly attachable to a transmission and a second housing portion, attachable to the first housing portion and directly attachable to the mating transfer case.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is an isometric view of an auxiliary gearbox according to one exemplary non-limiting embodiment of the invention.

FIG. 2 is an isometric view of a drivetrain incorporating the auxiliary gearbox of FIG. 1.

FIG. 3 is a top plan view of the auxiliary gearbox of FIG. 1.

FIG. 4 is an exploded view of a portion of the auxiliary gearbox of FIG. 1.

FIG. 5 is a side cross-sectional view of the auxiliary gearbox of FIG. 1 taken along line D-D shown in FIG. 3.

FIG. 6 is a side view of the auxiliary gearbox of FIG. 1.

FIG. 7 is a side view of the auxiliary gearbox of FIG. 1.

FIG. 8 is a rear view of the auxiliary gearbox of FIG. 1.

FIG. 9 is a front view of the auxiliary gearbox of FIG. 1.

FIG. 10 is a bottom view of the auxiliary gearbox of FIG. 1.

FIG. 11 is a side cross-sectional view of a drivetrain incorporating an auxiliary gearbox according to one embodiment of the invention.

FIG. 12A is a side cross-sectional view of an auxiliary gearbox with a range collar in a first position according to one embodiment of the invention. FIG. 12B is a side cross-sectional view of an auxiliary gearbox with a range collar in a second position according to one embodiment of the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of the invention provides an auxiliary gearbox for mounting to a transmission that was originally (e.g. from the factory) fitted to a VF series transfer case. The auxiliary gearbox may comprise one or more epicyclic gear sets. The auxiliary gearbox may provide a gear reduction of between 2:1 and 4:1. In some embodiments, the auxiliary gearbox provides a gear reduction of approximately 2.57:1. The auxiliary gearbox may be have a first configuration in which it provides a gear reduction and a second configuration in which the gear reduction is bypassed. In some embodiments, one or more components of the auxiliary gearbox may be similar to, or even repurposed from, components for a VF series transfer case.

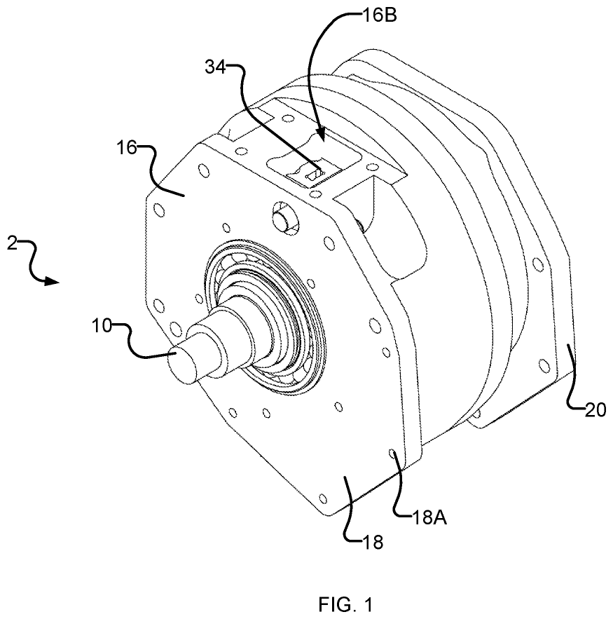

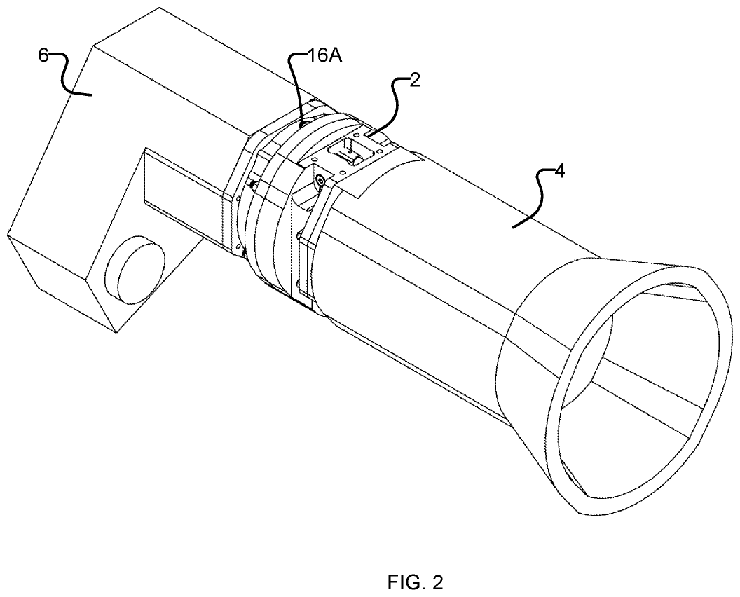

FIG. 1 depicts an auxiliary gearbox 2 according to an exemplary, non-limiting embodiment of the invention. Auxiliary gearbox 2 may be mountable between a transmission 4 and a transfer case 6, as shown in FIG. 2, to provide gear reduction beyond that provided by transfer case 6. Transmission 4 may comprise any suitable transmission such as an automatic transmission or a manual transmission. Transfer case 6 may comprise a VF series transfer case.

Auxiliary gearbox 2 comprises a housing 16. Housing 16 comprises a first housing portion 18 and a second housing portion 20. The components of housing 16 (e.g. first housing portion 18 and second housing portion 20) may be fabricated from metal (e.g. aluminum alloy, magnesium alloy or steel) or a suitable composite material. First housing portion 18 and second housing portion 20 may be attached to each other by one or more bolts 16A (see FIG. 2) or another suitable manner. One or more sealing features, such as a gasket, may be provided at the interface between first housing portion 18 and second housing portion 20 to prevent undesirable fluids or debris from entering housing 16.

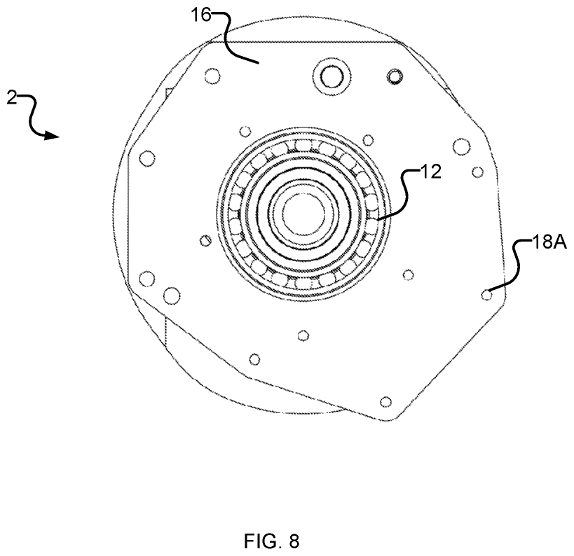

First housing portion 18 is configured to mount to transmission 4. For example, first housing portion 18 may comprise one or more mounting features 18A adapted to mount to one or more mounting features of transmission 4, as best shown in FIGS. 1 and 8. In some embodiments, first housing portion 18 may be bolted on to transmission 4 and mounting features 18A define one or more apertures for receiving bolts. In some embodiments, mounting features 18A may be arranged to match a bolt pattern of transmission 4. While exemplary bolt patterns are depicted, it should be understood that the depicted bolt patterns are meant to be illustrative and not restrictive.

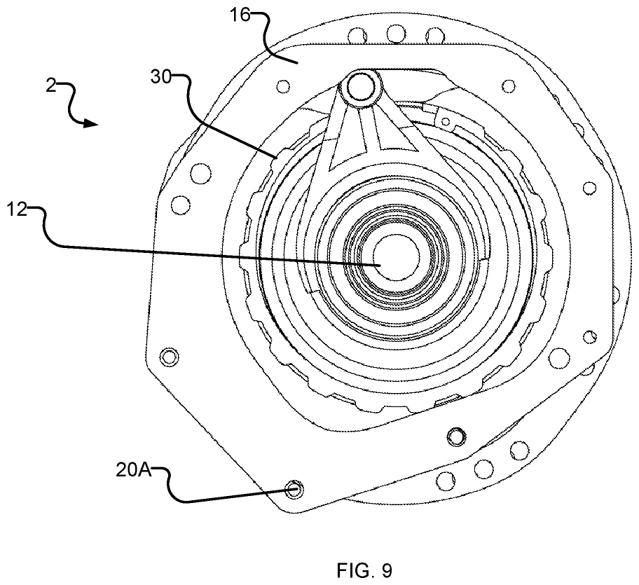

Similarly, second housing portion 20 is configured to mount to transfer case 6. For example, second housing portion 20 may comprise one or more mounting features 20A adapted to mount to one or more mounting features of transfer case 6, as best shown in FIG. 9. In some embodiments, transfer case housing 20 may be bolted on to transfer case 6 and mounting features 20A define one or more apertures for receiving bolts. In some embodiments, mounting features 20A may be arranged to match a bolt pattern of transfer case 6. While exemplary bolt patterns are depicted, it should be understood that the depicted bolt patterns are meant to be illustrative and not restrictive.

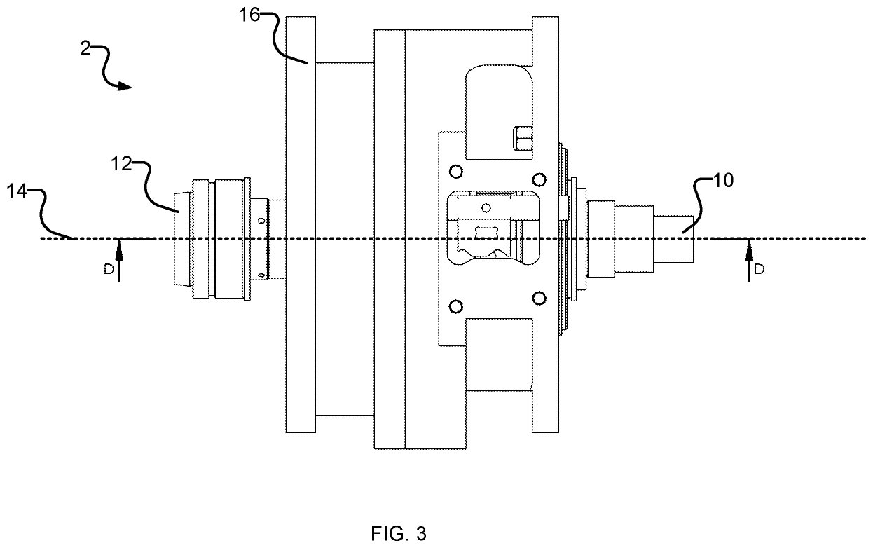

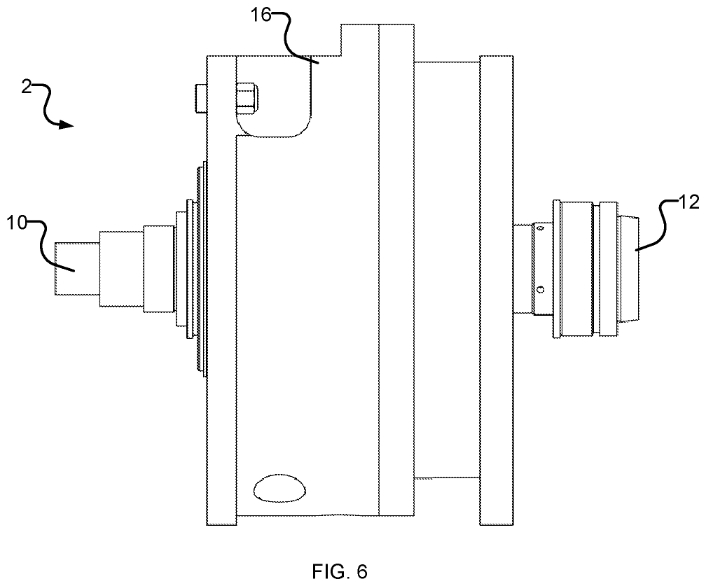

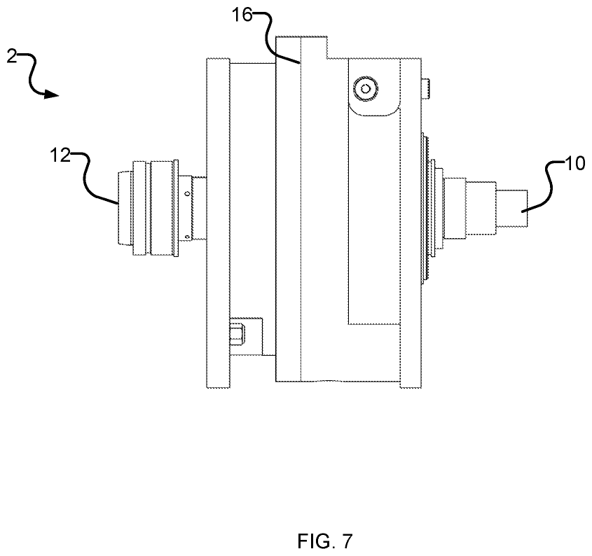

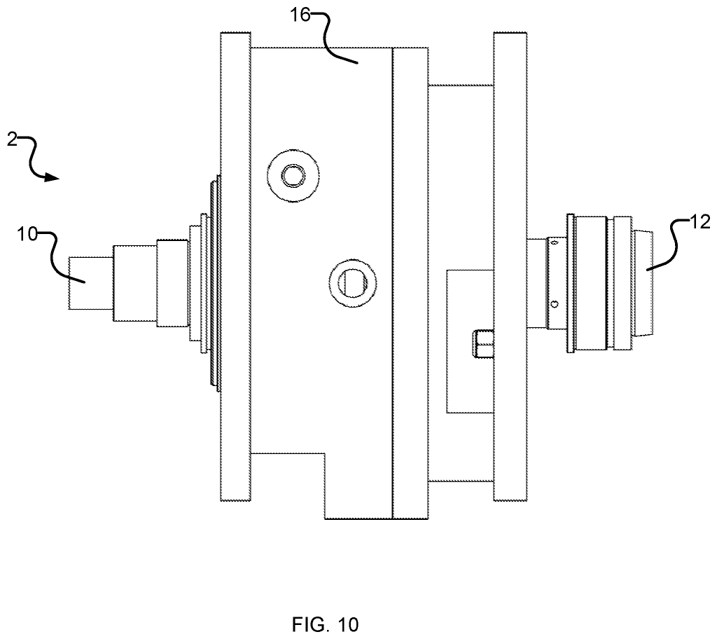

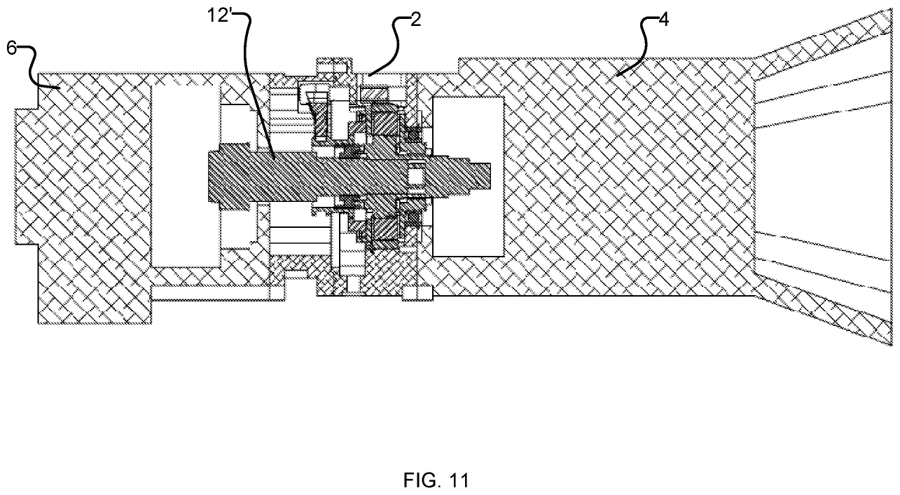

Auxiliary gearbox 2 comprises an input shaft 10 and an output shaft 12, as best shown in FIGS. 3, 6, 7 and 10. Input shaft 10 may be configured (e.g. shaped and sized) to mate to an output shaft (not depicted) of transmission 4. In some embodiments, input shaft 10 comprises an input shaft removed from (or manufactured for) a transfer case, such as a VF series transfer case. In some embodiments, output shaft 12 is configured (e.g. shaped and sized) to mate to an input shaft (not depicted) of transfer case 6. In some embodiments, output shaft 12 is integrally formed with the input shaft (not depicted) of transfer case 6. For example, the original (e.g. factory installed) input shaft of transfer case 6 may be replaced with an output shaft 12′ configured to replace the original input shaft of transfer case 6, as shown in FIG. 11. By integrating output shaft 12 and the input shaft (not depicted) of transfer case 6, the length of the drivetrain may be further reduced.

Rotation of input shaft 10 about a longitudinal axis 14 of auxiliary gearbox 2 may drive rotation of output shaft 12 about longitudinal axis 14. Auxiliary gearbox 2 may provide a gear reduction such that rotation of input shaft 12 at a first rate causes rotation of output shaft 12 at a second rate, lower than the first rate. In some embodiments, auxiliary gearbox 2 provides a gear reduction of between approximately 2:1 and 4:1 (e.g. such that the second rate is between approximately two and four times lower than the first rate). In some embodiments, auxiliary gearbox 2 provides a gear reduction of between approximately 2:1 and 3:1. In some embodiments, auxiliary gearbox 2 provides a gear reduction of approximately 2.57:1.

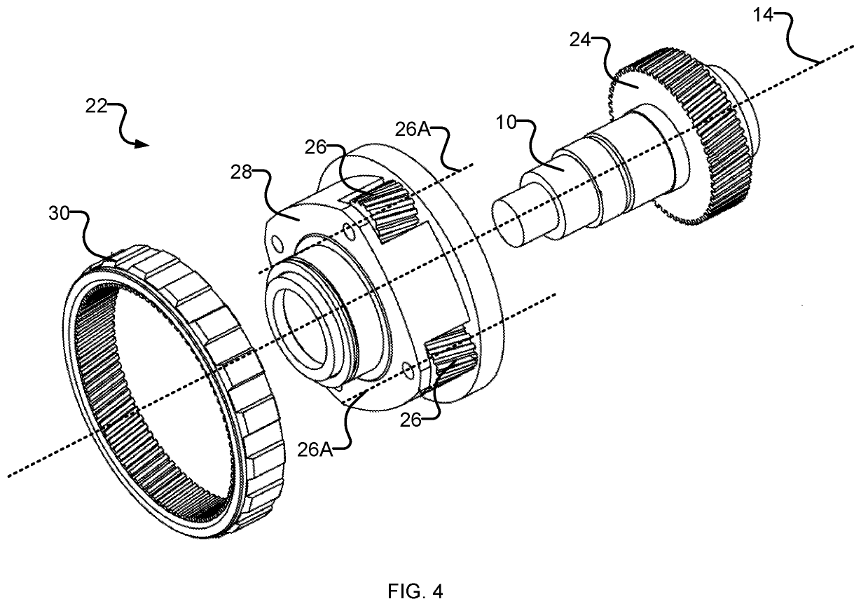

Auxiliary gearbox 2 may comprise an epicyclic gear set 22 for providing gear reduction between input shaft 10 and output shaft 12. Epicyclic gear set 22 may be located within housing 16, as shown in FIG. 4. Epicyclic gear set 22 comprises a sun gear 24, a plurality of planetary gears 26, a planetary gear carrier 28 and a ring gear 30. While the illustrated embodiment comprises four planetary gears 26, it should be understood that epicyclic gear set 22 may comprise three, four, five or more planetary gears 26. In some embodiments, epicyclic gear set 22 comprises an epicyclic gear set (or components thereof) removed from (or manufactured for) a transfer case, such as a VF series transfer case.

In one exemplary non-limiting embodiment, sun gear 24 comprises 53 teeth, each planetary gear 26 comprises 15 teeth and ring gear 30 comprises 83 teeth. In such an embodiment, epicyclic gear set 22 may provide a gear reduction of approximately 2.57:1.

Sun gear 24 may be fixed to input shaft 10 such that sun gear 24 rotates at the same rate as input shaft 10. As sun gear rotates, engagement of sun gear 24 with the plurality of planetary gears 26 may cause each of planetary gears 26 to rotate about their respective axes 26A. As planetary gears 26 rotate about their individual axes 26A, engagement between planetary gears 26 and ring gear 30 may cause rotation of planetary gear carrier 28 about longitudinal axle 14 of auxiliary gearbox 2 since ring gear 30 is fixed (e.g. to housing 16). Planetary gear carrier 28 may in turn be or connectable to output shaft 12 such that rotation of planetary gear carrier 28 about longitudinal axis 14 causes rotation of output shaft 12 about longitudinal axis 14.

In some embodiments, the connection between planetary gear carrier 28 and output shaft 12 is selectively engageable to allow output shaft 12 to alternatively be connected directly to input shaft 10 such that auxiliary gearbox 2 does not provide any gear reduction (e.g. input shaft 10 and output shaft 12 rotate with a 1:1 ratio).

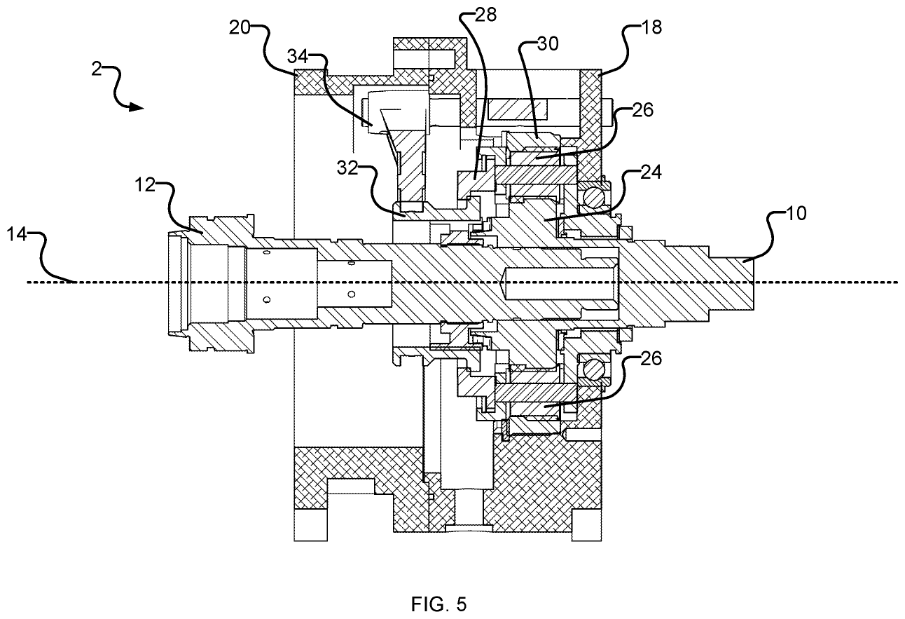

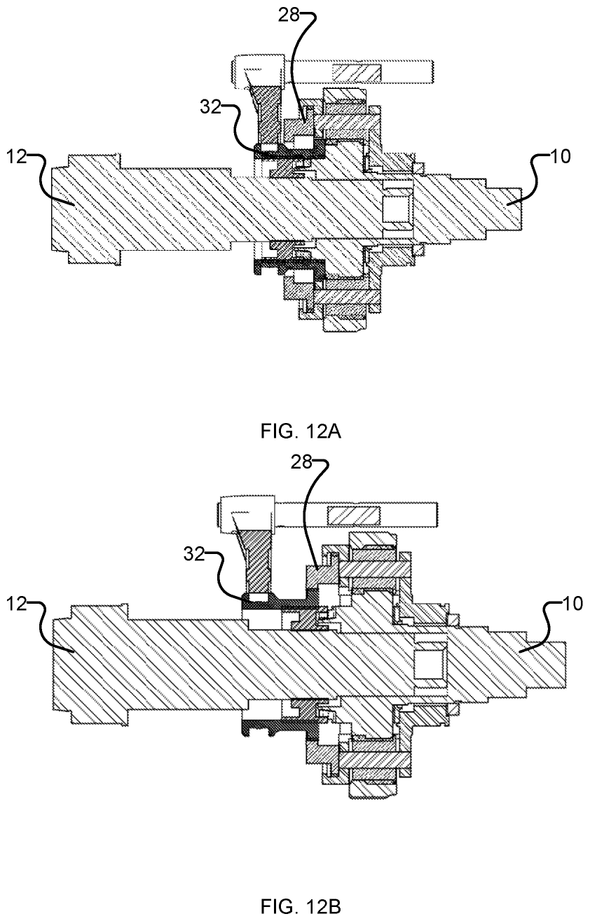

For example, in some embodiments, auxiliary gearbox 2 comprises a range collar 32 (shown in FIG. 5) operable between a first position and a second position. In the first position, range collar 32 connects output shaft 12 to input shaft 10 such that auxiliary gearbox 2 does not provide any gear reduction (e.g. input shaft 10 and output shaft 12 rotate with a 1:1 ratio). In the second position, range collar 32 connects output shaft 12 to planetary gear carrier 28 such that auxiliary gearbox 2 provides gear reduction as described herein. In some embodiments, range collar 32 is co-axial with output shaft 12 and configured to translate in a direction substantially parallel to longitudinal axis 14 along output shaft 12 between the first and second positions. For example, FIG. 12A shows range collar 32 in a first position connecting output shaft 12 to input shaft 10 while FIG. 12B shows range collar 32 in a second position connecting output shaft 12 to planetary gear carrier 28. In some embodiments, range collar 32 comprises a range collar (or parts thereof) removed from (or manufactured for) a transfer case, such as a VF series transfer case.

Range collar 32 may be selectively operable between the first and second positions by movement of a shift fork 34. Shift fork 34, or a rod, lever or the like attached to shift fork 34, may be arranged to extend into the cab of a 4-wheel drive vehicle upon which auxiliary gearbox 2 is installed to allow a vehicle operator to move range collar 32 between the first and second positions. In this way, auxiliary gearbox 2 can provide gear reduction, or no gear reduction, as desired. Housing 16 may define an aperture 16B to allow for access to shift fork 34. In some embodiments, shift fork 34 comprises a shift fork (or parts thereof or a modified version thereof) removed from (or manufactured for) a transfer case, such as a VF series transfer case.

In some embodiments, one or more parts of auxiliary gearbox 2 may be re-purposed from a pre-existing transfer case, such as a VF series transfer case. Additionally or alternatively, one or more parts of auxiliary gearbox 2 may comprise re-purposed parts that were manufactured as replacement parts for a transfer case, such as a VF series transfer case. In this way, auxiliary gearbox 2 may be less expensive to manufacture and/or repair since some parts may already be readily available for purchase or re-use. Similarly, repairing auxiliary gearbox 2 may be easier for mechanics (both professional and amateur) to repair as such mechanics may already be familiar with many components of auxiliary gearbox 2 which are common with a transfer case, such as a VF series transfer case.

In some embodiments, one or more components of auxiliary gearbox 2 may be sold as a kit. For example, in some embodiments, housing 16 and output shaft 12 are sold together as a kit without the parts that are common with a VF series transfer case (e.g. without epicyclic gear set 22, input shaft 10 and/or range collar 32). In that case, the purchaser of the kit could obtain one or more of the parts that are common with a VF series transfer case (e.g. without epicyclic gear set 22, input shaft 10 and/or range collar 32) from a VF series transfer case, or otherwise.

Since epicyclic gear reducing systems tend to be more compact and lighter than traditional gear reducing systems (e.g. as employed in an RF1A transfer case), auxiliary gearbox 2 may be lighter and more compact than prior art auxiliary gearboxes that re-purpose parts of an RF1A transfer case. Moreover, because housing 16 is purpose-built to fit transmission 4 and transfer case 6, housing 16 may be more compact than simply re-purposing housing parts of an RF1A transfer case which require additional adapters for mounting.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof; elements which are integrally formed may be considered to be connected or coupled;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

Where a component (e.g. a bolt, gear, etc.) is referred to above, unless otherwise indicated, reference to that component (including a reference to a “means”) should be interpreted as including as equivalents of that component any component which performs the function of the described component (i.e. that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described herein. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. An auxiliary gearbox comprising:
a VF series transfer case input shaft;
a VF series transfer case epicyclic gear set, the epicyclic gear set comprising:
a sun gear connected to the input shaft;
a plurality of planetary gears engaged with the sun gear;
a planetary gear carrier connected to each of the plurality of planetary gears; and
a ring gear engaged with each of the planetary gears;
a range collar;
an output shaft selectively engageable to the input shaft via the range collar when the range collar is in a first position and selectively engageable to the planetary gear carrier via the range collar when the range collar is in a second position;
a first housing portion, directly attachable to a transmission; and
a second housing portion, attached to the first housing portion and directly attachable to a transfer case;
wherein the first housing portion and the second housing portion together house the epicyclic gear set and the range collar.

2. The auxiliary gearbox according to claim 1 comprising a shift fork connected to the range collar to selectively move the range collar between the first position and the second position.

3. The auxiliary gearbox according to claim 2 wherein the shift fork is a VF series transfer case shift fork.

4. The auxiliary gearbox according to claim 2 wherein the shift fork is a modified VF series transfer case shift fork.

5. The auxiliary gearbox according to claim 2 wherein one of the first housing portion and the second housing portion defines an aperture to provide access to the shift fork.

6. The auxiliary gearbox according to claim 1 wherein the VF series transfer case epicyclic gear set provides a gear reduction of between approximately 2:1 and 4:1.

7. The auxiliary gearbox according to claim 1 wherein the VF series transfer case epicyclic gear set provides a gear reduction of between approximately 2:1 and 3:1.

8. The auxiliary gearbox according to claim 1 wherein the VF series transfer case epicyclic gear set provides a gear reduction of approximately 2.57:1.

9. The auxiliary gearbox according to claim 1 wherein the sun gear comprises 53 teeth, each of the plurality of planetary gears comprise 15 teeth and the ring gear comprises 83 teeth.

10. The auxiliary gearbox according to claim 1 wherein the VF series transfer case input shaft and the VF series transfer case epicyclic gear set are re-purposed from one or more VF series transfer cases.

11. The auxiliary gearbox according to claim 1 wherein the VF series transfer case input shaft and the VF series transfer case epicyclic gear set are re-purposed from parts manufactured for a VF series transfer case.

12. The auxiliary gearbox according to claim 1 wherein the VF series transfer case input shaft, the VF series transfer case epicyclic gear set and the range collar are re-purposed from one or more VF series transfer cases.

13. The auxiliary gearbox according to claim 1 wherein the VF series transfer case input shaft, the VF series transfer case epicyclic gear set and the range collar are re-purposed from parts manufactured for a VF series transfer case.

14. A drivetrain comprising:
the auxiliary gearbox of claim 1;
a transmission attached to the first housing portion; and
a transfer case attached to the second housing portion;
wherein the output shaft of the auxiliary gearbox is integrally formed with an input shaft of the transfer case.

15. A method of installing the auxiliary gearbox of claim 1 in a drivetrain, the method comprising:
attaching a transmission to the first housing portion;
attaching a transfer case to the second housing portion; and
replacing an input shaft of the transfer case with at least a portion of the output shaft of the auxiliary gearbox.

16. A method of fabricating an auxiliary gearbox, the method comprising:
re-purposing VF series transfer case input shaft;
re-purposing a VF series transfer case epicyclic gear set, the epicyclic gear set comprising:
a sun gear connected to the input shaft;
a plurality of planetary gears engaged with the sun gear;
a planetary gear carrier connected to each of the plurality of planetary gears; and
a ring gear engaged with each of the planetary gears;
providing a range collar;
providing an output shaft selectively engageable to the input shaft via the range collar when the range collar is in a first position and selectively engageable to the planetary gear carrier via the range collar when the range collar is in a second position;
providing a first housing portion, directly attachable to a transmission;
providing a second housing portion, attached to the first housing portion and directly attachable to a transfer case; and
attaching the first housing portion to the second housing portion to house the epicyclic gear set.

17. A method according to claim 16 comprising connecting a shift fork to the range collar to selectively move the range collar between the first position and the second position.

18. A method according to claim 17 wherein connecting a shift fork to the range collar comprises re-purposing a VF series transfer case shift fork and connecting the re-purposed VF series transfer case shift fork to the range collar.

19. A method according to claim 17 wherein connecting a shift fork to the range collar comprises modifying a VF series transfer case shift fork and connecting the modified VF series transfer case shift fork to the range collar.

20. A method according to claim 17 wherein one of the first housing portion and the second defines an aperture to provide access to the shift fork.

21. A method according to claim 16 wherein the VF series transfer case epicyclic gear set provides a gear reduction of between approximately 2:1 and 4:1.

22. A method according to claim 16 wherein the VF series transfer case epicyclic gear set provides a gear reduction of between approximately 2:1 and 3:1.

23. A method according to claim 16 wherein the VF series transfer case epicyclic gear set provides a gear reduction of approximately 2.57:1.

24. A method according to claim 16 wherein the sun gear comprises 53 teeth, each of the plurality of planetary gears comprise 15 teeth and the ring gear comprises 83 teeth.

25. A method according to claim 16 comprising re-purposing the VF series transfer case input shaft and the VF series transfer case epicyclic gear set from one or more VF series transfer cases.

26. A method according to claim 16 comprising re-purposing the VF series transfer case input shaft and the VF series transfer case epicyclic gear set from parts manufactured for a VF series transfer case.

27. A method according to claim 16 comprising re-purposing the VF series transfer case input shaft, the VF series transfer case epicyclic gear set and the range collar from one or more VF series transfer cases.

28. A method according to claim 16 comprising re-purposing the VF series transfer case input shaft, the VF series transfer case epicyclic gear set and the range collar from parts manufactured for a VF series transfer case.

29. A kit comprising a housing configured to receive gear components of a VF series transfer case and an output shaft for coupling said kit to a mating transfer case.

30. A kit according to claim 29 wherein the housing comprises:
a first housing portion, directly attachable to a transmission; and
a second housing portion, attachable to the first housing portion and directly attachable to the mating transfer case.
